(19) United States
(12) Patent Application Publication
(10) Pub. No.: US 2016/0026200 A1
(43) Pub. Date: Jan. 28, 2016

(54) POWER SUPPLY CIRCUIT

(71) Applicant: KABUSHIKI KAISHA TOSHIBA, Tokyo (JP)

(72) Inventors: Shuuji TODA, Kawasaki Kanagawa (JP); Kei KASAI, Toshima Tokyo (JP)

(21) Appl. No.: 14/633,671

(22) Filed: Feb. 27, 2015

(30) Foreign Application Priority Data
Jul. 24, 2014 (JP) 2014-150961

(51) Int. Cl. G05F 1/625

(52) U.S. Cl. CPC G05F 1/625

(57) ABSTRACT

A power supply circuit includes a charge pump circuit configured to generate an output voltage by boosting an input voltage received at an input terminal and to provide the output voltage at an output terminal. A current supply circuit of the power supply circuit includes a first current source that supplies a first current that increases with time. The current supply circuit supplies current to the input terminal of the charge pump circuit. An insulated gate field effect transistor has a control electrode connected to the output terminal of the charge pump circuit. The insulated gate field effect transistor has a first electrode receiving a first voltage and a second electrode outputting a second voltage to, for example, a load circuit. The level of the second voltage can be determined according to the levels of the output voltage of the charge pump circuit and the first voltage.

### CROSS-REFERENCE TO RELATED APPLICATION

This application is based upon and claims the benefit of priority from Japanese Patent Application No. 2014-150961, filed Jul. 24, 2014, the entire contents of which are incorporated herein by reference.

### FIELD

Embodiments described herein relate generally to a power supply circuit.

### BACKGROUND

In the related art, there is a power supply circuit called a booster load switching circuit, which includes an output MOS transistor having a low on-resistance. The booster load switching circuit generates a voltage higher than a power supply voltage by using a charge pump circuit and applies this voltage to a gate electrode of an output MOS transistor.

In the power supply circuit during activation, the larger a current that is supplied to the charge pump circuit, the shorter the rise time of the output voltage is. However, sometimes an inrush current may flow, depending on a load capacitance and a load resistance. Therefore, there is a problem that the inrush current may adversely affect electronic devices connected to the power supply circuit.

### DESCRIPTION OF THE DRAWINGS

FIG. 1 is a block diagram illustrating a power supply circuit according to a first embodiment.

FIG. 2 is a timing chart illustrating an operation of the power supply circuit according to the first embodiment.

FIG. 3 is a circuit diagram illustrating the power supply circuit according to the first embodiment.

FIG. 4 is a block diagram illustrating a power supply circuit of a comparative example.

FIG. 5 is a timing chart illustrating an operation of the power supply circuit of the comparative example.

FIG. 6 is a circuit diagram illustrating a power supply circuit according to a second embodiment.

FIG. 7 is a timing chart illustrating an operation of the power supply circuit according to the second embodiment.

FIG. 8 is a block diagram illustrating a power supply circuit according to a third embodiment.

FIG. 9 is a timing chart illustrating an operation of the power supply circuit according to the third embodiment.

FIG. 10 is a block diagram illustrating a power supply circuit according to a fourth embodiment.

FIG. 11 is a timing chart illustrating an operation of the power supply circuit according to the fourth embodiment.

FIG. 12 is a block diagram illustrating a power supply circuit according to a fifth embodiment.

FIG. 13 is a timing chart illustrating an operation of the power supply circuit according to the fifth embodiment.

FIG. 14 is a block diagram illustrating a power supply circuit according to a sixth embodiment.

FIG. 15 is a timing chart illustrating an operation of the power supply circuit according to the sixth embodiment.

### DETAILED DESCRIPTION

An object is to provide a power supply circuit that suppresses an inrush current.

In general, according to one embodiment, a power supply circuit includes a charge pump circuit having an input terminal and an output terminal. The charge pump circuit is configured to generate an output voltage by boosting an input voltage received at the input terminal and to provide the output voltage at the output terminal. The power supply circuit also includes a current supply circuit with at least a first current source. The first current source is configured to supply a first current at a first level that increases with time—that is, a plot of the first current level over time has a positive slope. The current supply circuit is configured to supply current to the input terminal of the charge pump circuit. An insulated gate field effect transistor of the power supply circuit has a control electrode connected to the output terminal of the charge pump circuit, a first electrode at which a first voltage is receivable, and a second electrode at which a second voltage is output. In some embodiments, the second voltage can have a level determined according to the output voltage supplied to the control electrode and the first voltage received at the first electrode.

Hereinafter, embodiments are described with reference to the drawings.

### First Embodiment

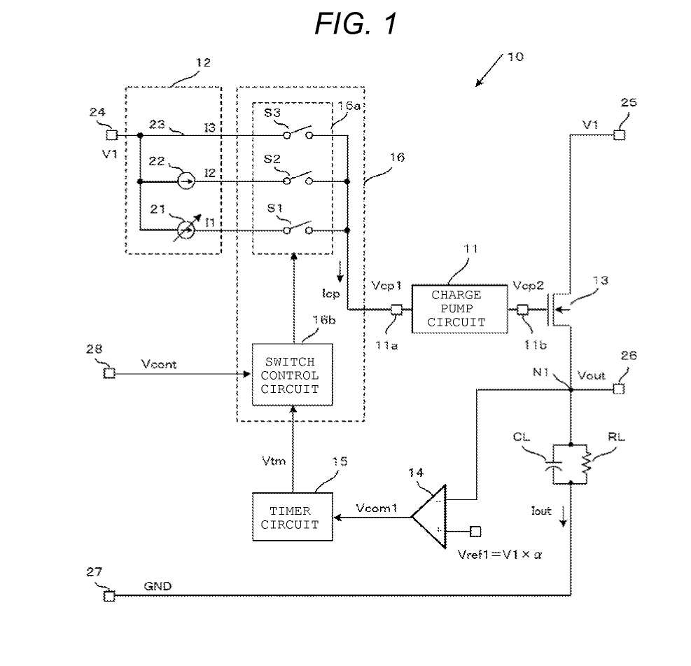

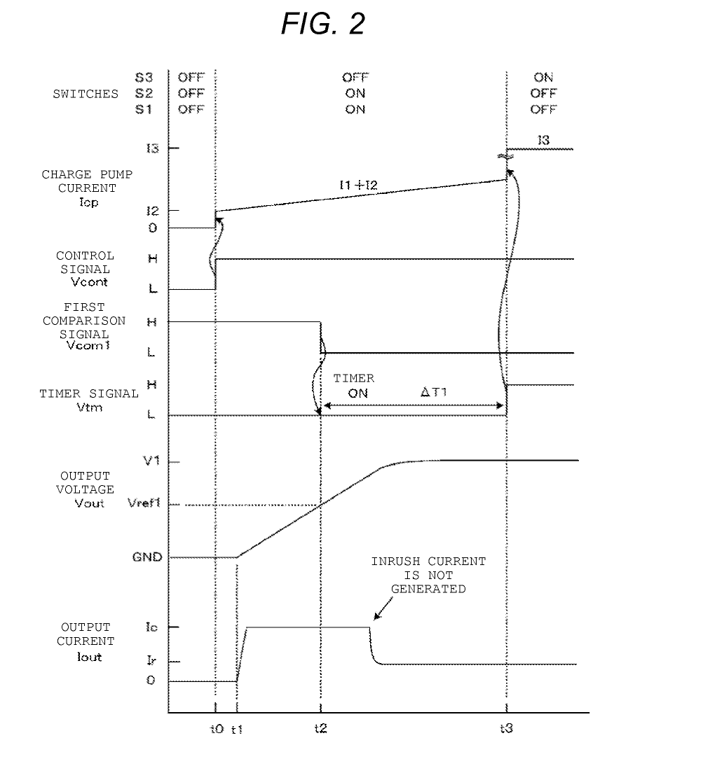

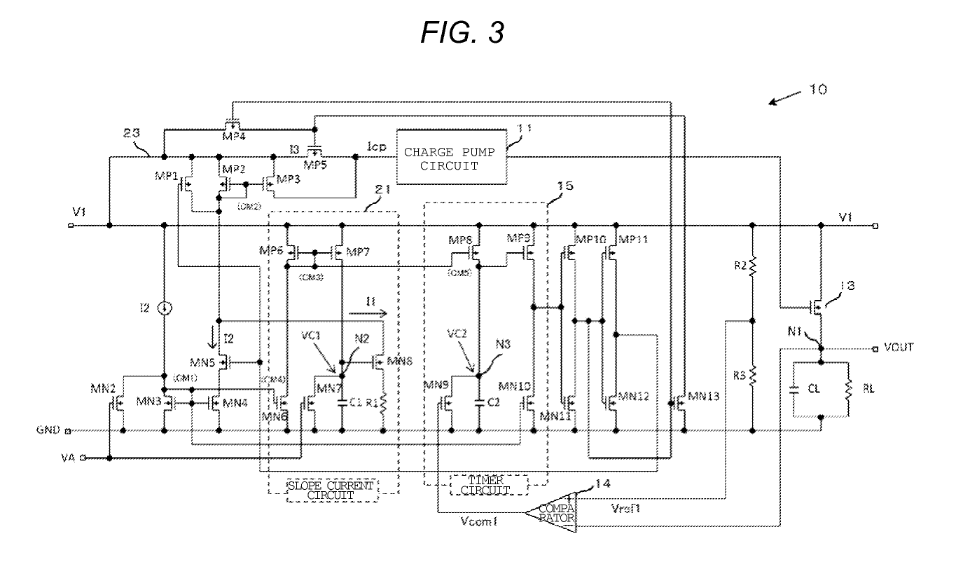

A description is given of a power supply circuit according to the first embodiment by using FIGS. 1 to 3. FIG. 1 is a block diagram illustrating a power supply circuit according to the first embodiment. FIG. 2 is a timing chart illustrating an operation of the power supply circuit and FIG. 3 is a circuit diagram illustrating the power supply circuit.

The power supply circuit according to the first embodiment is a power supply circuit and may be referred to as a booster load switching circuit. The power supply circuit includes an output MOS transistor having a low on-resistance. The booster load switching circuit generates a voltage higher than a power supply voltage by using a charge pump circuit, and applies this voltage to a gate electrode of the output MOS transistor.

In the MOS transistor, as the gate voltage becomes higher in a linear region, a drain current rises rapidly with respect to the drain voltage, and thus the low on-resistance is achieved.

As illustrated in FIG. 1, a power supply circuit 10 includes a charge pump circuit 11 that generates a charge pump output voltage Vcp2 by boosting a charge pump input voltage Vcp1, a current supply circuit 12 that supplies the charge pump circuit 11 with a charge pump current Icp, and an N channel insulated gate field effect transistor (hereinafter, referred to as output MOS transistor) 13 that converts a power supply voltage (first voltage) V1 into an output voltage (second voltage) Vout, in response to the charge pump output voltage Vcp2.

Further, the power supply circuit 10 includes a first comparator 14 that compares the output voltage Vout with a first reference voltage Vref1. Vref1 is obtained by dividing the power supply voltage V1. Comparator 14 outputs a first comparison signal (first comparison result) Vcom1. A timer circuit 15 starts counting time in response to the first comparison signal Vcom1 and outputs a timer signal (second signal) Vtm after a predetermined time ΔT elapses. Furthermore, a current selection circuit 16 is connected between the current supply circuit 12 and the charge pump circuit 11.

The current selection circuit 16 selects the magnitude of the charge pump current Icp in response to a control signal (first signal) Vcont (for activating the charge pump circuit 11) and the timer signal Vtm.

The charge pump circuit 11 is, for example, a Dickson-type charge pump circuit. The charge pump circuit 11 boosts the charge pump input voltage Vcp1 which is provided through an input terminal 11a, and outputs an output voltage Vcp2 higher than the charge pump input voltage Vcp1 at an output terminal 11b. The boost ratio (Vcp2/Vcp1) of the charge pump circuit 11 is, for example, approximately in a range from 2 to 5.

The principle of the charge pump circuit is described briefly. The charge pump circuit is, for example, a circuit for boosting an input voltage by repeating a process of, first, connecting a plurality of capacitors in parallel, next, charging the capacitors connected in parallel, and last, re-connecting the charged capacitors in series, in synchronization with a clock signal.

The current supply circuit 12 includes: a first current unit 21 for supplying a first current (hereinafter, referred to as a slope current) I1, which increases with time; a second current unit 22 for supplying a second current (hereinafter, referred to as a constant current) I2, which is constant with respect to time; and a third current unit 23 for supplying a third current, which is larger than the first current I1 and the second current I2.

The power supply voltage V1 is input to a voltage terminal 24. The first current unit 21 is a current source that converts the power supply voltage V1 into current and outputs the slope current I1. The second current unit 22 is a current source that converts the power supply voltage V1 into current and outputs the constant current I2.

As depicted in FIG. 1, the third current unit 23 is a wire connecting the voltage terminal 24 and the input terminal 11a. The power supply voltage V1 is provided directly (via element S3) to the input terminal 11a to supply current required for the steady-state operation of the charge pump circuit 11.

In the output MOS transistor 13, a gate electrode (control electrode) is connected to the output terminal 11b, a drain electrode (first electrode) is connected to a power supply terminal 25, and a source electrode (second electrode) is connected to a node N1.

The power supply voltage V1 is input to the power supply terminal 25. An output terminal 26 is connected to the node N1. External loads such as electronic devices (not illustrated) are connected to the output terminal 26.

A parallel circuit having a load capacitance CL and a load resistance RL is connected between the node N1 and a ground terminal 27. In one embodiment, the load capacitance CL and the load resistance RL are internal loads of the power supply circuit 10. The load capacitance CL and the load resistance RL are provided for the purpose of stabilizing the output voltage Vout during overload conditions and absorbing a reverse current when an external load is cut off.

The first comparator 14 is, for example, a differential amplifier. The output voltage Vout is provided to a negative input terminal, and the first reference voltage Vref1, which is obtained by dividing the power supply voltage V1, is provided to a positive input terminal. A division ratio α is, for example, 0.5. The first comparator 14 is provided to detect the magnitude of the output voltage Vout and determine whether the output voltage is rising (that is, output voltage is in a rising state).

The timer circuit 15 is, for example, a delay circuit using a charging time of a capacitor which is charged by a constant current. The timer circuit 15 is provided for driving the current selection circuit 16 after a predetermined time elapses from the detection of the rising state of the output voltage Vout.

The current selection circuit 16 includes a switch circuit 16a and a switch control circuit 16b. The switch circuit 16a includes a first switch S1 provided between the first current unit 21 and the input terminal 11a, a second switch S2 provided between the second current unit 22 and the input terminal 11a, and a third switch S3 provided between the third current unit 23 and the input terminal 11a.

The switch control circuit 16b turns on or off each of the first to third switches S1 to S3, in response to the control signal Vcont and the timer signal Vtm.

Next, the operation of the power supply circuit 10 is described.

As illustrated in FIG. 2, an initial state of the power supply circuit 10 is illustrated before time t0. In the initial state, the control signal Vcont and the timer signal Vtm are at a low state, the first comparison signal Vcom1 is at a high state, and the first to third switches S1, S2, and S3 are at an off (non-conducting) state. The capacitor of the load capacitance CL and the capacitor of the charge pump circuit 11 are not in a charged state.

At time t0, the control signal Vcont goes to a high state, the switch control circuit 16b in response turns on the first and second switches S1 and S2. Thus, the slope current I1 and constant current I2 flow to the charge pump circuit 11 (Icp=I1+I2).

At time t1, the charge pump output voltage Vcp2 starts to increase and the output voltage Vout increases, substantially linearly, in response to the charge pump output voltage Vcp2. The output current Iout charges the load capacitance CL (Iout=Ic).

The difference between time t1 and time t0 represents a time until when the charge pump output voltage Vcp2 starts rising after the capacitor(s) of the charge pump circuit 11 is/are charged. The constant current I2 is provided to shorten a time (t0 to t1) until the charge pump output voltage Vcp2 starts rising.

At time t2, when the output voltage Vout is greater than the first reference voltage Vref1, the comparator 14 switches states, causing the first comparison signal Vcom1 to go to a low state from a high state. When the first comparison signal Vcom1 goes to a low state, the timer circuit 15 is activated and starts counting time.

When a predetermined time ΔT1 elapses, the timer circuit 15 switches the timer signal Vtm to a high state. Time ΔT1 is set such that time t2+ΔT1 is longer than a time required for the output voltage Vout to rise to approximately the power supply voltage V1.

When the load capacitance CL is fully charged, the output current Iout flows to the load resistance RL (Iout=Ir). Between time t2 and time t3, the output voltage Vout rises to approximately the power supply voltage V1.

At time t3 (t2+ΔT1), when the timer signal Vtm goes to a high state, the switch control circuit 16b turns off the first and second switches S1 and S2, and turns on the third switch S3. Thus, a third current I3, which is larger than the slope current I1 and the constant current I2, flows to the charge pump circuit 11 (Icp=I3).

The third current I3 is a current required for the charge pump circuit 11 to maintain a predetermined charge pump output voltage Vcp2. In other words, the third current I3 is a current required for maintaining the fully charged state of the capacitor of the charge pump circuit 11.

Because switching to the third current I3 is performed after the output voltage Vout rises to approximately the power supply voltage V1, even if the third current I3, which is larger than the slope current I1 and the constant current I2, flows to the charge pump circuit 11, an inrush current is not generated.

Next, a description is given of an example of an equivalent circuit obtained by realizing the power supply circuit 10 as an integrated circuit.

As illustrated in FIG. 3, MOS transistors MN3 and MN4 configure a current mirror circuit CM1. MOS transistors MP2 and MP3 configure a current mirror circuit CM2. MOS transistors MP6 and MP7 configure a current mirror circuit CM3. MOS transistors MN3 and MN6 configure a current mirror circuit CM4. MOS transistors MP6 and MP8 configure a current mirror circuit CM5.

The MOS transistors MN2, MN5, MN7, MN9, MP1, MP4, MP5, and MN13 respectively serve as switches.

The MOS transistors MP10 and MN11, and the MOS transistors MP11 and MN12 are respectively inverters.

A voltage VA is a voltage corresponding to an inverted signal of the control signal Vcont. When the control signal Vcont is high, the voltage VA goes to a low state (e.g., GND), and when the control signal Vcont is low, the voltage VA goes to a high state (e.g., power supply voltage V1).

If the voltage VA is low, the MOS transistor MN2 is turned off, the constant current I2 flows to the MOS transistor MN3.

While the timer circuit 15 is not switched on (i.e., when the timer signal Vtm is Low), the MOS transistor MN5 is turned on, the MOS transistor MP1 is turned off, the MOS transistor MP4 is turned on, and the MOS transistor MP5 is turned off.

The sizes (a ratio W/L of a gate width W to a gate length L) of the MOS transistors MN3 and MN4 are set to be equal (thus, a mirror ratio of the current mirror circuit CM1 is 1). The sizes of the MOS transistors MP2 and MP3 are set to be equal (thus, a mirror ratio of the current mirror circuit CM2 is 1).

Accordingly, when the control signal Vcont is high and the timer circuit 15 is not switched (timer signal Vtm is Low), the constant current I2 flows to the charge pump circuit 11 (Icp=I2).

Next, a description will be given of the first current unit 21 as implemented in FIG. 3. As depicted in FIG. 3, the connection point between the drain electrode of the MOS transistor MN7 and a capacitor C1 is a node N2. When the voltage VA is high, the MOS transistor MN7 is an on-state, such that a voltage VC1 of the node N2 goes to a GND potential.

If the voltage VA is low, the MOS transistor MN7 is turned off, and the capacitor C1 is charged with a constant current I2×k (where k is the product of mirror ratios of the current mirror circuits CM3 and CM4) which is proportional to the constant current I2. The voltage VC1 of the node N2 goes to VC1=I2×k/C1, and increases in proportion to the time t.

The voltage VC1 is the gate voltage of the MOS transistor MN8. The gate voltage of the MOS transistor MN8 increases over time t and the current I1 flowing to the MOS transistor MN8 increases over time t. A resistor R1 is connected to the source electrode of the MOS transistor MN8. The current I1 increases with a slope that is proportional to 1/R1.

Thus, when the control signal Vcont is high and the timer circuit 15 is not switched, the current I1 flows to the charge pump circuit 11.

In short, when the control signal is high, and the timer circuit 15 is not switched, the current of I1+I2 flows through the charge pump circuit 11 (Icp=I1+I2). I1 is a current increasing with a slope that is proportional to 1/R1, and the charge pump output voltage Vcp2 increases linearly. Since the charge pump output voltage Vcp2 is applied to the gate electrode of the output MOS transistor 13, the output voltage Vout also increases linearly.

Next, a description is given of the timer circuit 15 as depicted in FIG. 3. The connection point between the drain electrode of the MOS transistor MN9 and a capacitor C2 is a node N3. The gate electrode of the MOS transistor MN9 is connected to the output terminal of the comparator 14.

The first reference voltage Vref1=V1×R3/(R2+R3) is applied to the positive input terminal of the comparator 14. For example, when R2=R3, the first reference voltage is set to Vref1=V1×0.5. The negative input terminal is connected to the node N1, and the output voltage Vout is applied thereto.

When the output voltage Vout is less than the first reference voltage Vref1 (Vout<Vfre1), the first comparison signal Vcom1 is high and the MOS transistor MN9 is turned on. As a result, a voltage VC2 of the node N3 goes to a ground potential GND.

If the output voltage Vout is greater than the first reference voltage Vref1 (Vout>Vfre1), the first comparison signal Vcom1 goes to a low state and the MOS transistor MN9 is turned off. As a result, a constant current I2×m (m is a mirror ratio of the current mirror circuit CM5) which is proportional to the constant current I2 flows to the capacitor C2.

If the capacitor C2 is charged, the voltage VC2 of the node N3 goes to I2×m×t/C2, and increases in proportion to the time t.

The threshold voltage of a MOS transistor MP9 is set to Vthp. If the terminal voltage VC2 is greater than “V1−|Vthp|”, the MOS transistor MP9 is turned off, the inverter configured with the MOS transistors MP10 and MN11 and the inverter configured with the MOS transistors MP11 and MN12 are inverted, the timer circuit 15 is switched, the MOS transistor MP3 is turned off, and the MOS transistor MP5 is turned on.

As a result, the charge pump circuit 11 is not supplied with the slope current I1 and the constant current I2 which flow through the MOS transistor MP3, and is supplied with the third current I3 through the MOS transistor MP5.

The time ΔT1, until the timer circuit 15 is switched after the capacitor C2 begins to be charged, is (V1−|Vthp|)×C2/(I2×m). The timer time ΔT1 may be set by adjusting the current mirror ratio m.

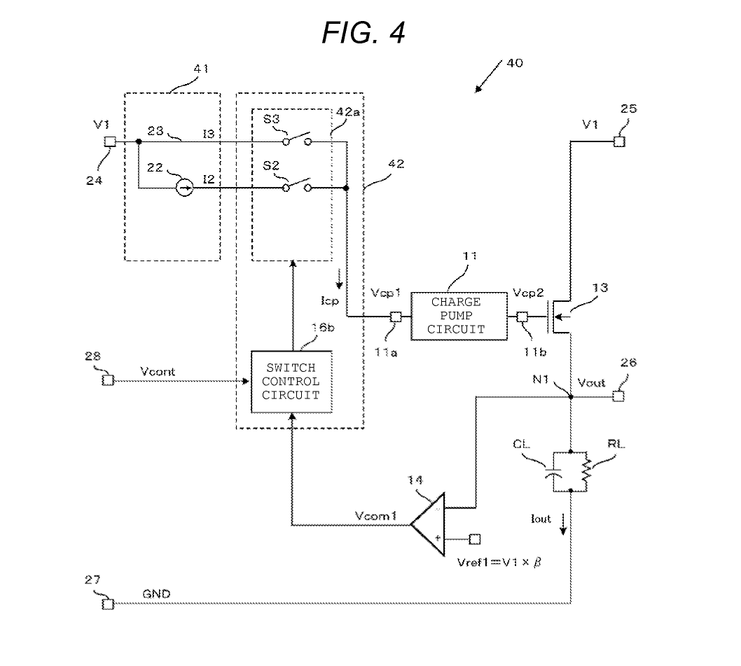

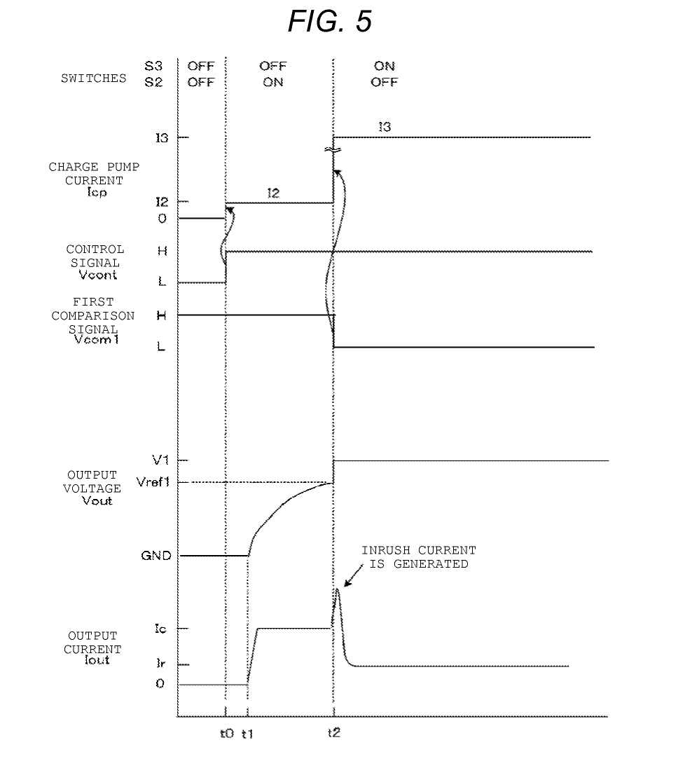

Next, a description is given of a power supply circuit of a comparative example and the operation thereof. FIG. 4 is a block diagram illustrating the power supply circuit of the comparative example. FIG. 5 is a timing chart illustrating an operation of a power supply circuit 40 of the comparative example. Here, the power supply circuit of the comparative example is a power supply circuit without the first current unit 21 and the timer circuit 15.

As illustrated in FIG. 4, the power supply circuit 40 of the comparative example includes a current supply circuit 41 including the second current source 22 and the third current unit 23, and a current selection circuit 42. A switch circuit 42a of the current selection circuit 42 includes the second switch S2 and the third switch S3.

As illustrated in FIG. 5, at time t0, when the control signal Vcont goes to a high state, the switch control circuit 16b turns on the second switch S2. Only the constant current I2 is supplied to the charge pump circuit 11 as the charge pump current Icp, and the output voltage Vout rises accordingly.

At time t2, when the output voltage Vout goes to V1×β (β is an number, for example, 0.9) which is the first reference voltage Vref1 the second switch S2 is turned off, and the third switch S3 is turned on, such that the charge pump current Icp is switched into the third current I3 which is larger than the constant current I2.

However, since the output voltage Vout has not completely risen to the power supply voltage V1, an inrush current is generated at the time of switching.

Since the amount of charge accumulated in the capacitor of the charge pump circuit 11 is proportional to the charge pump current Icp, if the constant current I2 is excessively reduced, due to variations in manufacturing process or the like, the charge pump output voltage Vcp2 may be lower than a target value. Thus, the output voltage Vout is saturated before the output voltage Vout has risen completely to the power supply voltage V1 in some cases.

If the output voltage Vout is saturated at less than V1×0.9, the charge pump current Icp is not switched. Therefore, the output voltage Vout does not rise to the power supply voltage V1.

As described above, the power supply circuit 10 of the first embodiment includes the current supply circuit 12 for supplying the charge pump circuit 11 with the slope current I1 and the constant current I2 which are the charge pump current Icp, at the time of rising, the first comparator 14 for actuating the timer circuit 15 when the output voltage Vout reaches the predetermined first reference voltage Vref1, and the timer circuit 15 for switching the charge pump current Icp into the third current I3 when the predetermined time ΔT1 elapses.

As a result, the slope current I1 continues to flow until the output voltage Vout rises to the intended level (e.g., power supply voltage V1). After the output voltage Vout rises to the power supply voltage V1, it is possible to switch the charge pump current Icp into the third current I3 supply state (e.g., close switch S3). Accordingly, it is possible to achieve a power supply circuit that avoids an inrush current at the time of rising.

Since there is no sufficient charge pump current Icp at the time of rising, the output voltage Vout is saturated without rising to the power supply voltage V1, and thus there is no problem in that the charge pump current Icp is switched into the third current I3.

When the saturated output voltage Vout is less than the first reference voltage Vref1, there is no problem in that the charge pump current Icp does not rise to the power supply voltage V1 without being switched into the third current I3.

The case in which the power supply voltage V1 is input to the voltage terminal 24 is described, but the voltage at voltage terminal 24 may be different from the power supply voltage V1. The voltage input to the voltage terminal 24 may change appropriately depending on, for example, the boost ratio of the charge pump circuit. If the boost ratio is high, the voltage supplied at voltage terminal 25 maybe reduced to lower than the power supply voltage V1, and if the boost ratio is low, the voltage supplied at voltage terminal 24 may be increased to higher than the power supply voltage V1.

The case above is described in which the output MOS transistor is the n-channel MOS transistor, but a p-channel MOS transistor is also possible and the first embodiment may be varied accordingly.

The case is described in which the control signal Vcont at the initial state is low, but it is possible to set the control signal Vcont to be high in the initial state, and to set the voltage VA to the voltage corresponding to the control signal Vcont.

The power supply circuit 10 may be mainly realized as an analog circuit, but the power supply circuit 10 of the present disclosure is not particularly limited to implementation as an analog circuit. The power supply circuit 10 may be a circuit including a digital circuit.

### Second Embodiment

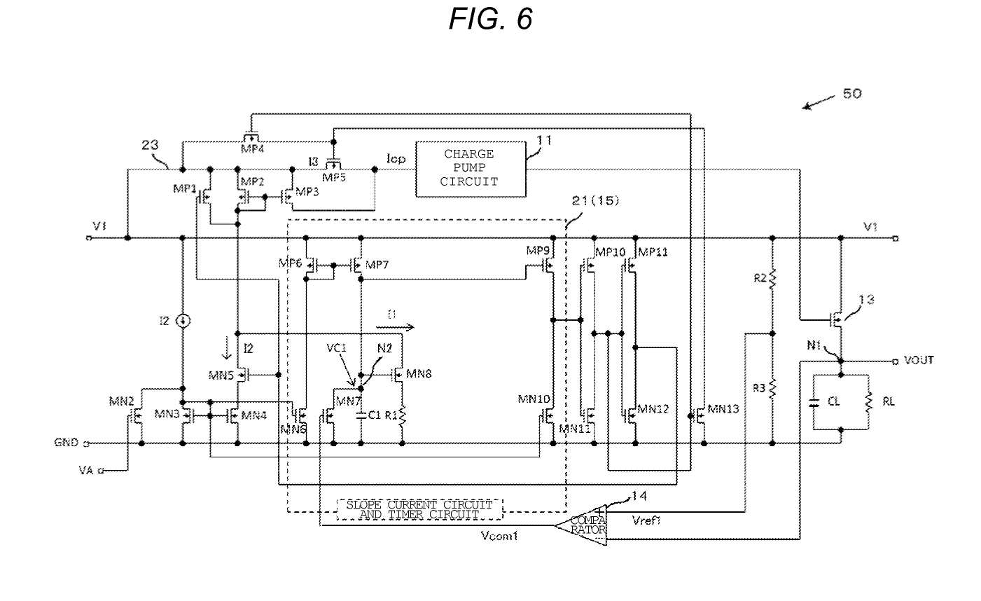

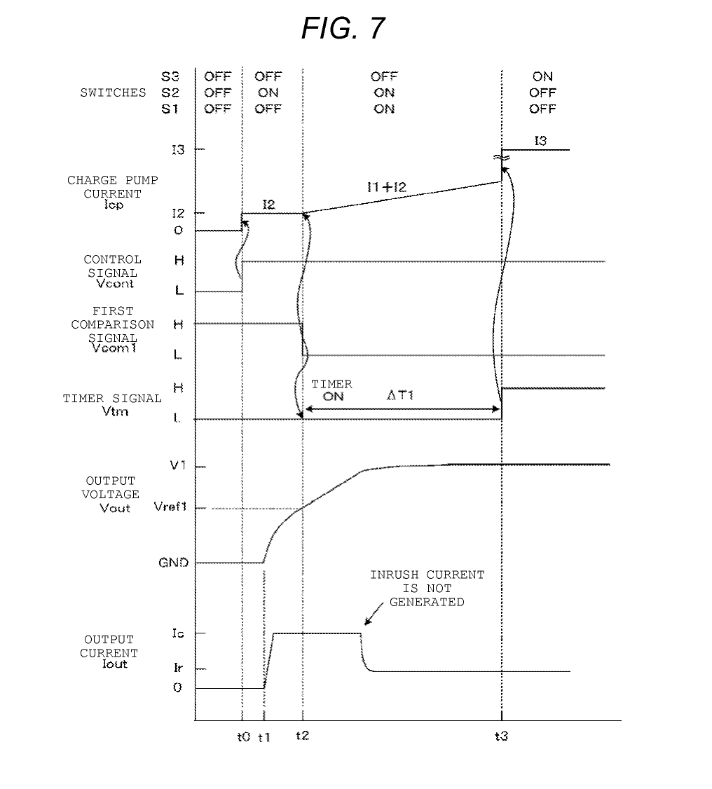

A power supply circuit according to the second embodiment is described with reference to FIGS. 6 and 7. FIG. 6 is a circuit diagram illustrating the power supply circuit according to the second embodiment. FIG. 7 is a timing chart illustrating an operation of the power supply circuit according to the second embodiment.

In the second embodiment, the same components as those of the first embodiment are denoted by the same reference symbols, the description thereof is omitted, and different parts are described. The second embodiment is different from the first embodiment in that first current unit also serves as a timer circuit.

In other words, as illustrated in FIG. 6, a power supply circuit 50 is a power supply circuit obtained by excluding the MOS transistors MP8 and MN9 and the capacitor C2 from the power supply circuit 10 illustrated in FIG. 3. The gate electrode of the MOS transistor MP9 is connected to node N2. The gate electrode of the MOS transistor MN7, which is a switch, is connected to the output terminal of the comparator 14.

If the output voltage Vout reaches the first reference voltage Vref1=V1×R3/(R2+R3), the MOS transistor MN7 is turned off, and the slope current I1 flows. If the voltage VC1 of node N2 increases and the MOS transistor MP9 is turned off and the timer circuit is switched.

As illustrated in FIG. 7, at time t0, when the control signal Vcont goes to a high state, the second switch S2 is turned on, and the constant current I2 flows to the charge pump circuit 11 (Icp=I2).

At time t2, when the output voltage Vout is greater than the first reference voltage Vrfe1, the first comparison signal Vcom1 goes to a low state, the first switch S1 is turned on, and the slope current I1 flows to the charge pump circuit 11 (Icp=I1+I2) and the timer is activated (starts counting the time ΔT1).

At time t3, when the predetermined time ΔT1 elapses, the first and second switches S1 and S2 are turned off, the third switch S3 is turned on, and the charge pump current Icp is switched into the third current I3.

Since the predetermined time ΔT1 is set to be equal to or greater than a time required for the output voltage Vout to rise to approximately the power supply voltage V1, an inrush current is not generated.

In the power supply circuit 50, it is not possible to independently set the slope of the slope current I1 or adjust the predetermined time ΔT1, a timer time ΔT1 Depends on the slope of the slope current I1. If the slope of the slope current I1 is large, the timer time ΔT1 is short, and if the slope is small, the timer time ΔT1 is long.

As described above, since the power supply circuit 50 according to the present embodiment also serves as the first current unit 21 and the timer circuit 15, the number of components configuring the power supply circuit is reduced. Accordingly, there is an advantage of reducing the area of an integrated circuit chip in which the power supply circuit is provided.

### Third Embodiment

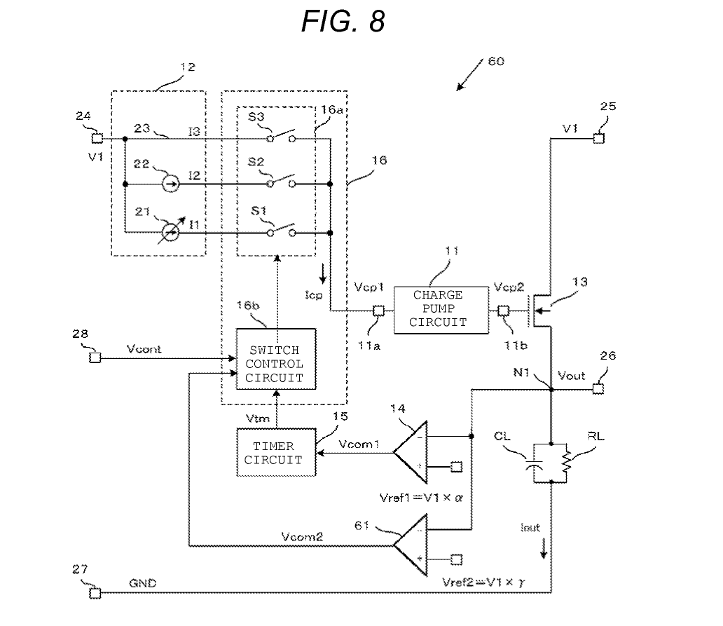

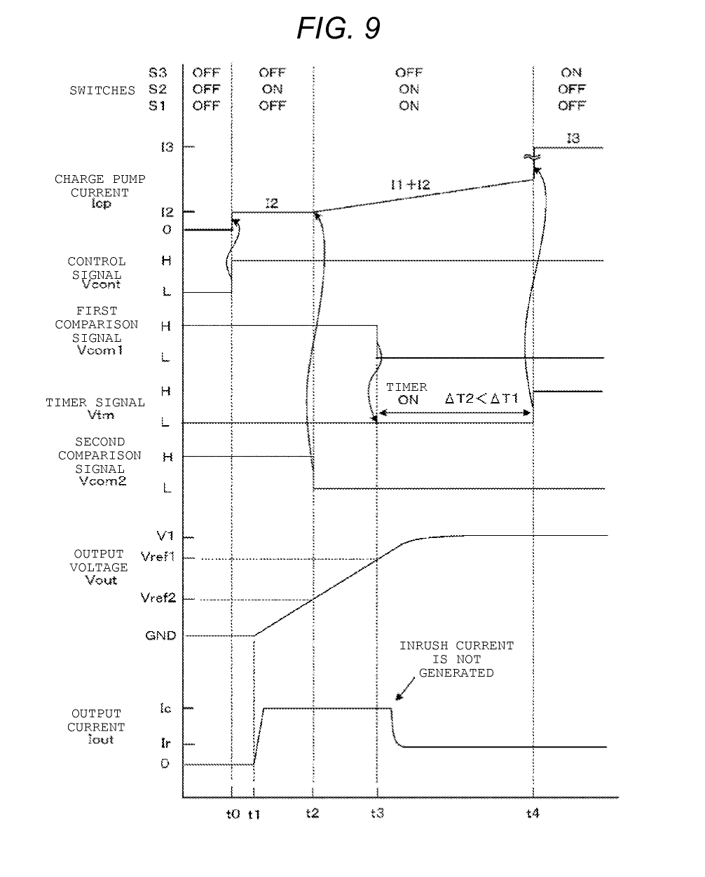

A power supply circuit according to the third embodiment will be described with reference to FIGS. 8 and 9. FIG. 8 is a block diagram illustrating the power supply circuit according to the third embodiment. FIG. 9 is a timing chart illustrating an operation of the power supply circuit according to the third embodiment.

In the third embodiment, the same components as those of the first embodiment are denoted by the same reference symbols, the description thereof is omitted, and different parts are described. The third embodiment is different from the first embodiment in that a second comparator is included.

As illustrated in FIG. 8, a power supply circuit 60 according to the third embodiment includes a second comparator 61. In the second comparator 61, a negative input terminal is connected to node N1, a second reference voltage Vref2 is input to the positive input terminal, and a second comparison signal (second comparison result) Vcom2 is output to the switch control circuit 16b.

The second reference voltage Vref2 is a voltage which is obtained by dividing the power supply voltage V1, and is represented by V1×γ. The second reference voltage Vref2 is set to be smaller than, for example, the first reference voltage Vref1.

As illustrated in FIG. 9, at time t0, when the control signal Vcont goes to a high state, the second switch S2 is turned on, and the constant current I2 goes to the charge pump circuit 11 (Icp=I2). The output voltage Vout is delayed (e.g., until capacitors in the charge pump circuit 11 charge) and starts to rise at time t1.

At time t2, when the output voltage Vout is higher than the second reference voltage Vref2, the second comparison signal Vcom2 goes to a low state. The first switch S1 is turned on, and the slope current I1 and the constant current I2 flow to the charge pump circuit 11 (Icp=I1+I2).

At time t3, when the output voltage Vout is greater than the first reference voltage Vref1, the first comparison signal Vcom1 goes to a low state, and the timer circuit 15 is activated (begins counting).

At time t4 (t3+ΔT2), the timer signal Vtm goes to a high state. The first and second switches S1 and S2 are turned off, the third switch S3 is turned on, and the charge pump current Icp is switched into the third current I3 (Icp=I3).

As described above, since the power supply circuit 60 according to the third embodiment includes two comparators, there is an advantage in which a timing at which the slope current I1 flows to the charge pump circuit 11, and a timing at which the timer circuit 15 is activated, that is, a timing at which the charge pump current Icp is switched into the third current I3, may be independently set. It is possible to set the predetermined time ΔT2 of the timer circuit 15 to be shorter than the predetermined time ΔT1 used in the first and second embodiments.

### Fourth Embodiment

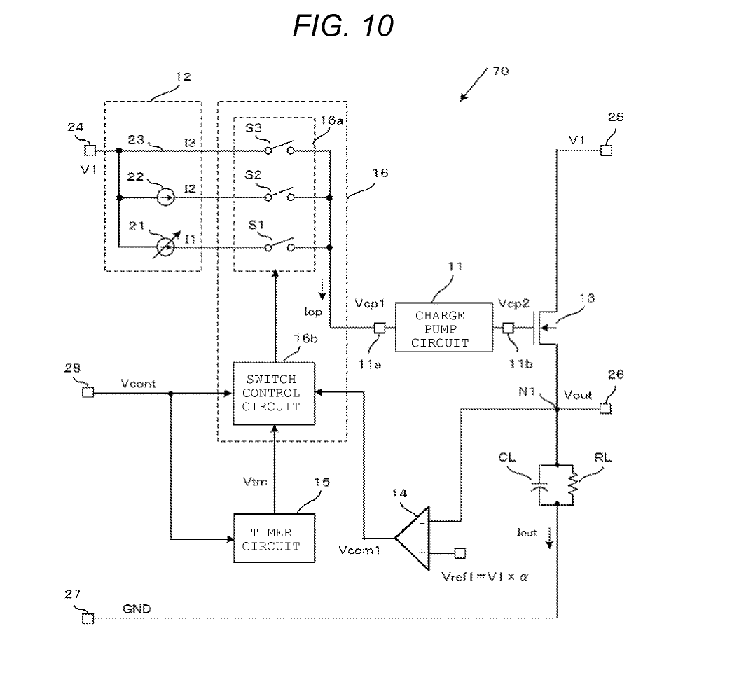

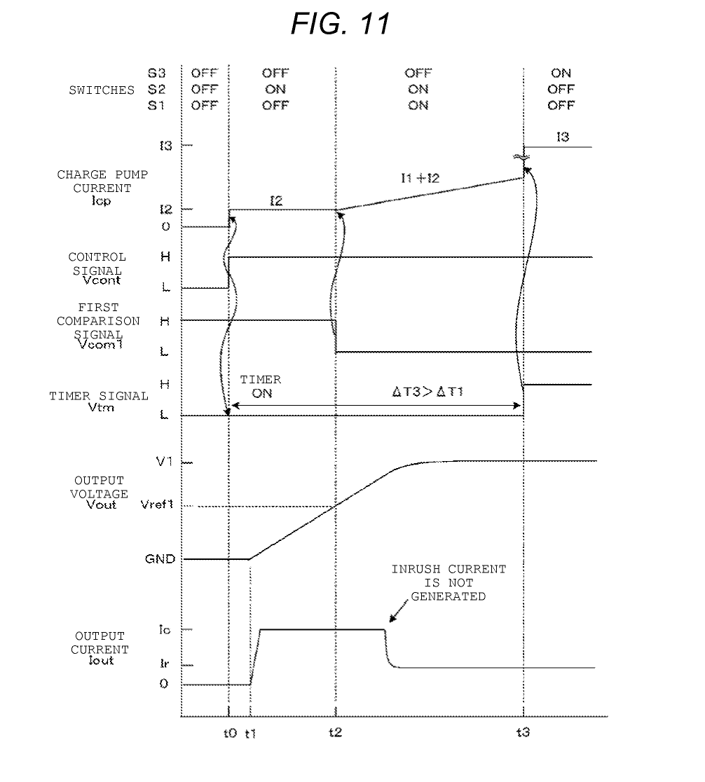

A power supply circuit according to the fourth embodiment is described with reference to FIGS. 10 and 11. FIG. 10 is a block diagram illustrating the power supply circuit according to the fourth embodiment. FIG. 11 is a timing chart illustrating an operation of the power supply circuit according to the fourth embodiment.

In the fourth embodiment, the same components as those according to the first embodiment are denoted by the same reference symbols, the description thereof is omitted, and different parts are described. The fourth embodiment is different from the first embodiment in that the timer circuit is activated by a control signal.

As illustrated in FIG. 10, with respect to a power supply circuit 70 according to the fourth embodiment, the control signal Vcont is input to the switch control circuit 16b and the timer circuit 15, and the first comparison signal Vcom1 is input to the switch control circuit 16b.

As illustrated in FIG. 11, at time t0, when the control signal Vcont goes to a high state, the second switch S2 is turned on, and the constant current I2 flows to the charge pump circuit 11 (Icp=I2). At the same time, the timer circuit 15 is activated and starts counting time. The output voltage Vout is delayed (e.g., for the charging time of capacitors in charge pump 11) and starts rising at time t1.

At time t2, if the output voltage Vout is greater than the first reference voltage Vref1, the first comparator 14 switches a first comparison signal Vcom1 to a low state. In response, the switch control circuit 16b turns on the first switch S1, the slope current I1 and the constant current I2 flow to the charge pump circuit 11 (Icp=I1+I2).

At time t3, when a predetermined time ΔT3 elapses, the timer circuit 15 switches the timer signal Vtm to a high state. In response, the switch control circuit 16b turns off the first and second switches S1 and S2, and turns on the third switch S3, the charge pump current Icp is switched into the third current I3 (Icp=I3).

As described above, the power supply circuit 70 activates the timer circuit 15 with the control signal Vcont, and makes the slope current I1 flow in response to the first comparison signal Vcom1. Thus, in the fourth embodiment, when the charge pump current Icp is switched to the third current I3, an inrush current is not generated.

Because the predetermined time ΔT3 of the timer circuit 15 is longer than the time ΔT1, the capacitance of the capacitor C2 illustrated in FIG. 3 is set to be larger than the capacitance required for obtaining the time ΔT1.

### Fifth Embodiment

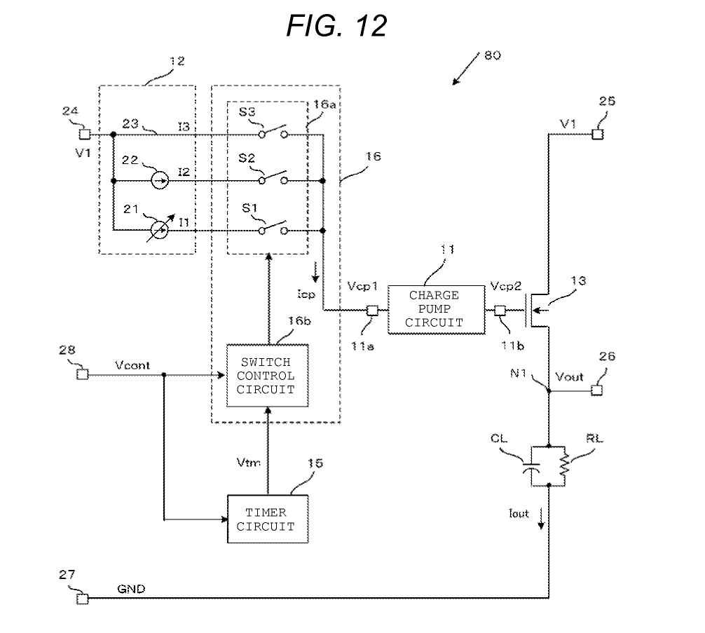

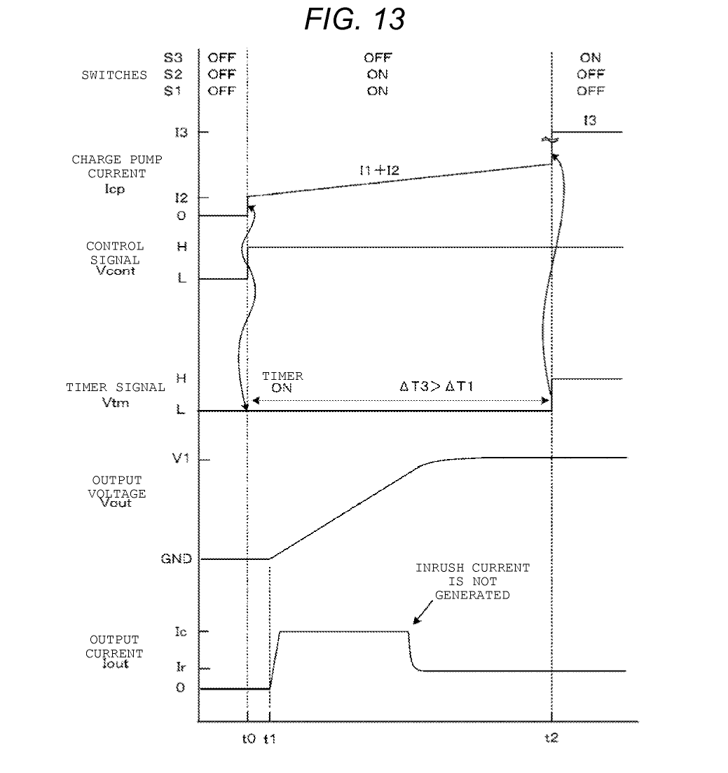

A power supply circuit according to the fifth embodiment is described with reference to FIGS. 12 and 13. FIG. 12 is a block diagram illustrating the power supply circuit according to the fifth embodiment. FIG. 13 is a timing chart illustrating an operation of the power supply circuit according to the fifth embodiment.

In the fifth embodiment, the same components as those of the first embodiment are denoted by the same reference symbols, the description thereof is omitted, and different parts are described. The fifth embodiment is different from the first embodiment in that the first comparator 14 is not included.

As illustrated in FIG. 12, a power supply circuit 80 according to the fifth embodiment does not include the first comparator 14. The control signal Vcont is sent to and activates the timer circuit 15.

As illustrated in FIG. 13, at time t0, when the control signal Vcont switches to a high state, the switch control circuit 16b turns on the first and second switches S1 and S2, such that the slope current I1 and the constant current I2 flow to the charge pump circuit 11 (Icp=I1+I2). At the same time, the timer circuit 15 is activated and starts counting time.

The output voltage Vout is delayed and starts rising at time t1. Even after the output voltage Vout rises, the slope current I1 and the constant current I2 continue to flow.

At time t3, when the predetermined time ΔT3 elapses, the timer circuit 15 switches the timer signal Vtm to a high state. In response, the switch control circuit 16b turns off the first and second switches S1 and S2, and turns on the third switch S3, such that the charge pump current Icp is switched into the third current I3 (Icp=I3).

As described above, the timer circuit 15 is activated by the control signal Vcont, and the slope current I1 and constant current I2 flow in response to the control signal Vcont. In the fifth embodiment, even when the charge pump current Icp is switched into the third current I3, an inrush current is not generated.

Here, the case is described in which the slope current I1 and the constant current I2 flow to the charge pump circuit 11, but the constant current I2 need not flow. It is possible to achieve an effect of the present disclosure by only supplying the slope current I1.

### Sixth Embodiment

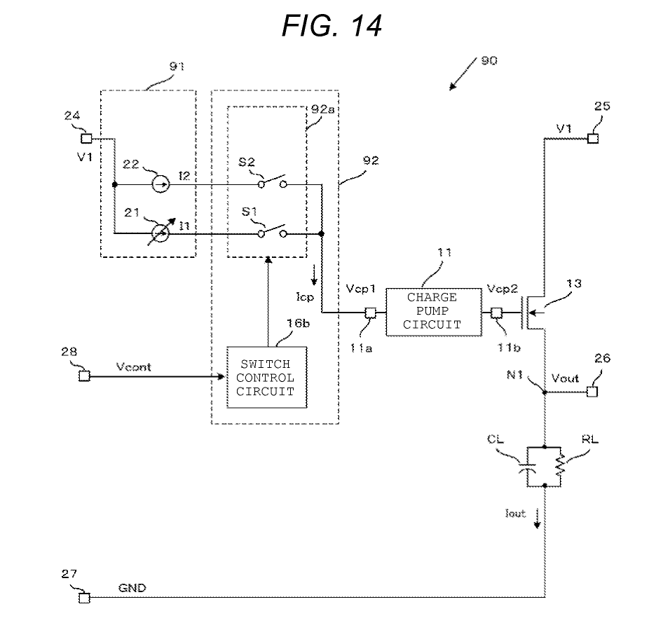

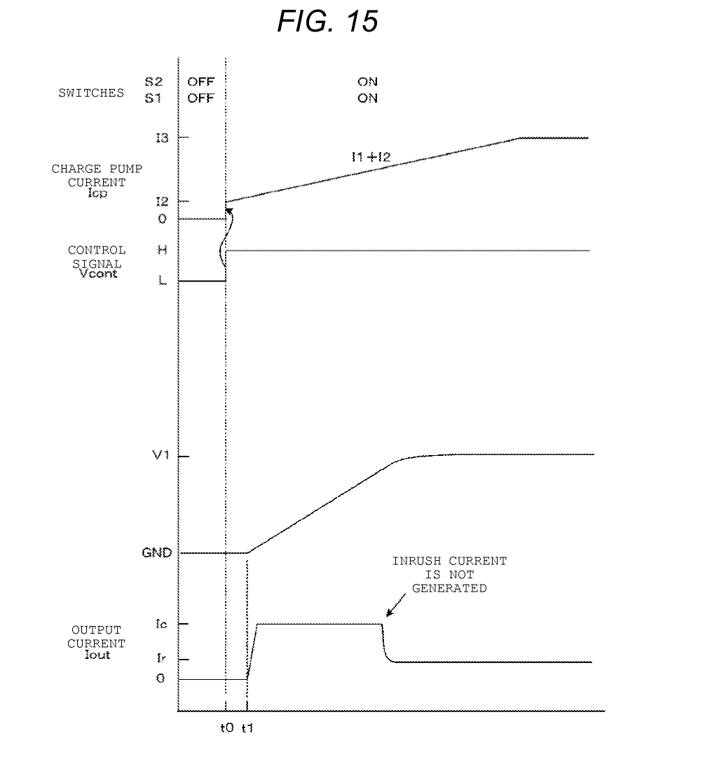

A power supply circuit according to the sixth embodiment is described with reference to FIGS. 14 and 15. FIG. 14 is a block diagram illustrating the power supply circuit according to the sixth embodiment. FIG. 15 is a timing chart illustrating an operation of the power supply circuit according to the sixth embodiment.

In the sixth embodiment, the same components as those of the first embodiment are denoted by the same reference symbols, the description thereof is omitted, and different parts are described. The sixth embodiment is different from the first embodiment in that the third current unit is not included.

In other words, as illustrated in FIG. 14, in a power supply circuit 90 according to the sixth embodiment, a current supply circuit 91 includes the first and second current units, and does not include the third current unit 23. A switch circuit 92a of a current selection circuit 92 includes the first and second switches S1 and S2, and does not include the third switch S3.

Since the third current I3 is not used in the sixth embodiment, the timer circuit 15 for switching the charge pump current Icp to the third current I3, and the first comparator 14 for activating the timer circuit 15 are not required.

As illustrated in FIG. 15, at time t0, when the control signal Vcont becomes a high state, the switch control circuit 16b turns on the first and second switches S1 and S2, and thus the slope current I1 and the constant current I2 flow to the charge pump circuit 11 (Icp=I1+I2).

At time t1, the output voltage Vout starts rising. Even after the output voltage Vout rises, the slope current I1 and the constant current I2 continue to flow to the charge pump circuit 11.

The slope current I1 and the constant current I2 are set so as to provide the current required for the steady-state operation of the charge pump circuit 11. If the slope current I1 and the constant current I2 reach the current required for the steady-state operation, the charge pump current Icp does not increase anymore and goes to approximately the constant level provided by the third current unit 23 in other embodiments.

In order that the slope current I1 flow for long time, the capacitance of the capacitor C1 illustrated in FIG. 3 may be set to be large.

As described above, in the power supply circuit 90, the slope current I1 and the constant current I2 flow only to the charge pump circuit 11. In the sixth embodiment, the charge pump current Icp is not switched into the third current I3, such that an inrush current is not generated.

Here, the case is described in which the slope current I1 and the constant current I2 flow to the charge pump circuit 11, but the constant current I2 need not flow. It is possible to achieve the effect of the sixth embodiment only by the slope current I1.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein maybe made without departing from the spirit of the inventions. The accompanying claims and their equivalents are intended to cover such forms or modifications as would fall within the scope and spirit of the inventions.

In addition, configurations described above the following variations are possible.

In the power supply circuit including a current selection circuit, the current selection circuit can select the first current when the charge pump circuit is initially activated.

In the power supply circuit including a current selection circuit and at least two current sources, the current selection circuit can select both the first and second currents when the charge pump circuit is initially activated.

In the power supply circuit including a current selection circuit and at least two current sources, the current selection circuit can select the second current when the charge pump circuit is initially activated, and then later select both the first and second currents in response to a detected rising state of the second voltage.

In the power supply circuit including a current supply circuit, the current supply circuit can include a capacitor that is charged with a constant current, and a serial circuit of an insulated gate field effect transistor of which a gate electrode is connected to one end of the capacitor, and through which the first current flows in response to a rise of a terminal voltage of the capacitor, and a resistor.

In the power supply circuit including, a timer circuit, the timer circuit can include a capacitor that is charged with a constant current, and an insulated gate field effect transistor of which a gate electrode is connected to one end of the capacitor, and if a terminal voltage of the capacitor rises to a predetermined value, the insulated gate field effect transistor is inverted.

What is claimed is:

1. A power supply circuit, comprising:
a charge pump circuit including an input terminal and an output terminal and configured to generate an output voltage by boosting an input voltage received at the input terminal and to provide the output voltage at the output terminal;
a current supply circuit including a first current source that is configured to supply a first current at a first level that increases with time, the current supply circuit configured to supply current to the input terminal of the charge pump circuit; and
an insulated gate field effect transistor including a control electrode connected to the output terminal of the charge pump circuit, a first electrode at which a first voltage is receivable, and a second electrode at which a second voltage is output.

2. The power supply circuit according to claim 1, wherein the current supply circuit includes a second current source configured to supply a second current at a second level that is constant with time.

3. The power supply circuit according to claim 2, further comprising:
a current selection circuit connected between the current supply circuit and the input terminal of the charge pump circuit and configured to selectively supply at least one of the first and second currents as current to the input terminal of the charge pump circuit.

4. The power supply circuit according to claim 3, wherein the current supplied to the input terminal of the charge pump circuit includes the first and second currents.

5. The power supply circuit according to claim 3, wherein
the current supply circuit further includes a third current source configured to supply a third current at a third level that is higher than the first and second levels, and
the current selection circuit is further configured to selectively supply the third current as current to the input terminal of the charge pump circuit when the second voltage is at or above a predetermined level.

6. The power supply circuit according to claim 1, further comprising:
a timer circuit configured to start a delay period upon receiving a first control signal then output a second control signal upon expiration of the delay period.

7. The power supply circuit according to claim 6, wherein the first control signal is supplied from outside the power supply circuit.

8. The power supply circuit according to claim 6, wherein the first control signal is supplied by a first comparator circuit configured to compare the second voltage to a first reference voltage, the first control signal corresponding to a comparison of the second voltage and the first reference voltage.

9. The power supply circuit according to claim 8, further comprising:
a second comparator circuit configured to compare the second voltage to a second reference voltage different from the first reference voltage and to supply a third control signal according to the comparison of the second voltage to the second reference voltage.

10. A power supply circuit, comprising:
a charge pump circuit including an input terminal and an output terminal and configured to generate an output voltage by boosting an input voltage received at the input terminal and to provide the output voltage at the output terminal;
a current supply circuit including a first current source that is configured to supply a first current at a first level that increases with time and a second current source that is configured to supply a second current at a second level that is constant with time;
a current selection circuit connected between the current supply circuit and the input terminal of the charge pump circuit, the current selection circuit configured to selectively supply current from the current supply circuit to the input terminal of the charge pump circuit according to a first control signal; and
an insulated gate field effect transistor including a control electrode connected to the output terminal of the charge pump circuit, a first electrode at which a first voltage is receivable, and a second electrode at which a second voltage is output.

11. The power supply circuit according to claim 10, wherein the current selection circuit includes:
a first switch connected between the first current source and the input terminal of the charge pump circuit;
a second switch connected between the second current source and the input terminal of the charge pump circuit; and
a switch control circuit configured to switch the first and second switches according to the first control signal.

12. The power supply circuit according to claim 10, further comprising:
a first comparator circuit configured to compare the second voltage with a first reference voltage that is obtained by dividing the first voltage and to output a first comparison signal according to the comparison of the second voltage with the first reference voltage.

13. The power supply circuit according to claim 12, wherein the first comparison signal is supplied directly to the current selection circuit.

14. The power supply circuit according to claim 12, wherein the first comparison signal is supplied to a timer circuit configured to output a second control signal to the current selection circuit after a predetermined time period elapses after the first comparison signal is received.

15. The power supply circuit according to claim 10, further comprising:
a timer circuit configured to receive the first control signal then output a second control signal to the current selection circuit after a predetermined time elapses after the first control signal is received.

16. The power supply circuit according to claim 10, wherein the current supply circuit further includes a third current source configured to supply a third current at a third level that is constant with time and higher than the first and second levels.

17. The power supply circuit according to claim 16, wherein the current selection circuit includes:
a first switch connected between the first current source and the input terminal of the charge pump circuit;
a second switch connected between the second current source and the input terminal of the charge pump circuit;
a third switch connected between the third current source and the input terminal of the charge pump circuit; and
a switch control circuit configured to close the first and second switches in response to the first control signal and to close the third switch and open the first and second switches in response to a timer control signal supplied by a timer circuit.

18. The power supply circuit according to claim 16, wherein the current selection circuit includes:
a first switch connected between the first current source and the input terminal of the charge pump circuit;
a second switch connected between the second current source and the input terminal of the charge pump circuit;
a third switch connected between the third current source and the input terminal of the charge pump circuit; and
a switch control circuit configured to close the second switch in response to the first control signal, to close the first switch, while the second switch remains closed, in response to a first comparison signal received from a first comparator circuit that is configured to compare the second voltage to a reference voltage, and to close the third switch and open the first and second switches in response to a timer control signal supplied by a timer circuit.

19. A method for controlling a booster load switching circuit, comprising:
supplying a first current to an input terminal of a charge booster circuit, the first current having a first level that increases with time, the charge booster circuit having an output terminal connected to a control electrode of an output transistor; and
after supplying the first current for a time period, supplying a second current instead of the first current to the input terminal of the charge booster circuit, the second current having a second level that is constant with time and sufficient to saturate the output transistor.

20. The method of claim 19, wherein the time period is a predetermined length that is set by a timer circuit.
